(19) United States
(12) Patent Application Publication
(10) Pub. No.: US 2025/0066543 A1
(43) Pub. Date: Feb. 27, 2025

(54) FURANDICARBOXYLATE POLYMER

(71) Applicant: FAR EASTERN NEW CENTURY CORPORATION, Taipei City (TW)

(72) Inventors: Chun-Ju HSU, Taipei City (TW); Jui-Yun TSAI, Taipei City (TW); Li-Ling CHANG, Taipei City (TW)

(21) Appl. No.: 18/761,474

(22) Filed: Jul. 2, 2024

(30) Foreign Application Priority Data
Aug. 22, 2023 (TW) 112131531

(51) Int. Cl. C08G 63/676; C08G 63/78

(52) U.S. Cl. CPC C08G 63/676; C08G 63/78

(57) ABSTRACT

A furandicarboxylate polymer has a character index that ranges from 0.27 to 0.55 and that is calculated using the following Equation: Character index=[(AC₁×Mn₁÷(2×10⁶)], where AC₁ represents an acid value of the furandicarboxylate polymer, and Mn₁ represents a number average molecular weight of the furandicarboxylate polymer.

### CROSS-REFERENCE TO RELATED APPLICATION

This application claims priority to Taiwanese Invention Patent Application No. 112131531, filed on Aug. 22, 2023, and incorporated by reference herein in its entirety.

### FIELD

The present disclosure relates to a polyester, and more particularly to a furandicarboxylate polymer.

### BACKGROUND

Polyethylene terephthalate is a polyester material which is widely used for making products in daily appliances, for example, plastic bottles for soft drinks. However, increase of environmental awareness in recent years has led to polyethylene terephthalate made of raw petrochemical materials to be widely replaced by bio-polyester materials, for example, polyethylene furanoate, abbreviated as PEF. Since polyethylene furanoate has a structure different from a structure of polyethylene terephthalate, the synthesis techniques, processing conditions and physical properties of polyethylene furanoate differ from those of polyethylene terephthalate. For example, in order to confer a polyester with appropriate mechanical strength, a solid-state polymerization process will be applied to increase the intrinsic viscosity and molecular weight of the resultant polyester. In the synthesis of polyethylene terephthalate, the solid-state polymerization process would merely require 3 hours to 5 hours to be completed, whereas in the synthesis of polyethylene furanoate, the solid-state polymerization process would require more than 20 hours to be completed.

In order to solve the problem of excessively long time period required for the solid-state polymerization process in the synthesis of polyethylene furanoate, U.S. Pat. No. 10,590,235 B2 discloses a polyester which is formed by subjecting a reactant composition that includes a 2,5-furandicarboxylate compound and ethylene glycol to a polymerization reaction at a temperature of 245° C. to 270° C. for 1.5 hours to 4 hours. The 2,5-furandicarboxylate compound includes at least one of 2,5-furandicarboxylic acid and dialkyl ester of 2,5-furandicarboxylic acid. The 2,5-furandicarboxylate compound and the ethylene glycol are present in a molar ratio of 1:1 and 1:4. The polyester has a number average molecular weight of 10000 to 25000, an acid value (i.e., carboxyl end group content) in a range of 35 meq/kg to 70 meq/kg, a melting point of at least 215° C., and an intrinsic viscosity of 0.45 dL/g to 1.0 dL/g. The polyester can be subjected to the solid-state polymerization reaction, and can be converted to a high molecular weight polymer product in a short period of time.

U.S. Pat. No. 9,890,242 B2 discloses a polyester which is formed by subjecting a reactant composition that includes 2,5-furandicarboxylic acid and ethylene glycol to a polymerization reaction at a temperature of 245° C. to 270° C. for 1.5 hours to 4 hours. The 2,5-furandicarboxylic acid and the ethylene glycol are present in a molar ratio of 1:1.01 to 1:1.15. The polyester has an acid value (i.e., carboxyl end group content) in a range of 15 meq/kg to 122 meq/kg, an intrinsic viscosity of 0.45 dL/g to 1.0 dL/g, and a melting point of at least 215° C. The polyester can be subjected to the solid-state polymerization reaction, and can be converted to a high molecular weight polymer product in a short period of time.

U.S. Pat. No. 11,174,344 B2 discloses a poly(tetramethylene-2,5-furandicarboxylate) polymer which has a melting point of 168° C. to 175° C., a number average molecular weight of at least 40000, and an absorbance of at most 0.05. The poly(tetramethylene-2,5-furandicarboxylate) polymer can be subjected to the solid-state polymerization reaction, and can be converted to a high molecular weight polymer product in a short period of time.

Although the polyesters and the polymers disclosed in the aforesaid patent documents can be respectively converted to high molecular weight polymer products in a short period of time during the solid-state polymerization reaction, when such polyesters and polymers are subjected to a thermal treatment, in particular the melting procedures of the thermal treatment, the problem of ester bond breakage still easily occurs due to thermal cracking, which affects the required properties of the polyesters and the polymer products, and thus the polyesters and the polymer products are likely to have a poor thermal processing stability.

Japanese Patent No. 5928655 B2 discloses a method for preparing a polyester resin from dicarboxylic acid component and a glycol component, and such method involves use of a specific aluminum compound as a catalyst and a phosphorus compound as an auxiliary catalyst in a polymerization process, so as to obtain the polyester resin with good thermally stable property. Since this patent document teaches use of a specific aluminum compound as a catalyst, the reaction conditions in the method for preparing the polyester resin might be relatively stringent, resulting in limited operability. In addition, use of the aluminum compound as a catalyst incurs a high cost and such aluminum compound is not easily obtainable, causing the thus prepared polyester resin prepared by the method to have a problem of high processing cost, which is not conducive to meet the requirements for commercial mass production.

In view of the aforesaid shortcomings, those skilled in the art strive to develop a polyester which can be prepared using a general catalyst and which has thermal stability when subjected to thermal treatment.

### SUMMARY

Therefore, an object of the present disclosure is to provide a furandicarboxylate polymer that can alleviate at least one of the drawbacks of the prior art.

According to an aspect of the present disclosure, the furandicarboxylate polymer has a character index ranging from 0.27 to 0.55. The character index is calculated using the following Equation (A): Character index=[AC₁×Mn₁÷(2×10⁶)], where AC₁ represents an acid value of the furandicarboxylate polymer, and Mn₁ represents a number average molecular weight of the furandicarboxylate polymer.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

### <Furandicarboxylate Polymer>

The present disclosure provides a furandicarboxylate polymer which includes at least one of furandicarboxylate polyester and a solid-state polymerized polyester that is formed by subjecting the furandicarboxylate polyester to a solid-state polymerization reaction. The furandicarboxylate polyester is formed by subjecting a reactant composition which includes a polycarboxylic (—COO—) component and a polyol component to a condensation and polymerization reaction.

In certain embodiments, a molar ratio of the polycarboxylic component and the polyol component ranges from 1.0:1.1 to 1.0:3.0.

In certain embodiments, the polycarboxylic component includes at least one first polycarboxylic compound selected from furandicarboxylic acid or furandicarboxylic acid diester. Examples of the furandicarboxylic acid include, 2,5-furandicarboxylic acid and 2,4-furandicarboxylic acid, but are not limited thereto. Examples of the furandicarboxylic acid diester include dimethyl furan-2,5-dicarboxylate and dimethyl furan-2,4-dicarboxylate, but are not limited thereto. In certain embodiments, the first polycarboxylic compound is present in an amount that is not smaller than 80 mol % and less than 100 mol % based on 100 mol % of the polycarboxylic component. In certain embodiments, the polycarboxylic component further includes a second polycarboxylic compound that is different from the first polycarboxylic compound. Examples of the second polycarboxylic compound include terephthalic acid, isophthalic acid, and 5-sulfoisophthalic acid sodium salt, but are not limited thereto.

The polyol component includes at least one C₂-C₄ first polyol compound. An example of the C₂-C₄ first polyol compound includes ethylene glycol, but is not limited thereto. In certain embodiments, the C₂-C₄ first polyol compound is present in an amount that is not smaller than 85 mol % and less than 100 mol % based on 100 mol % of the polyol component. In certain embodiments, the polyol component further includes a second polyol compound that is different from the C₂-C₄ first polyol compound. Examples of the second polyol compound include C₅-C₁₄ polyols, but are not limited thereto.

In certain embodiments, the condensation and polymerization reaction is conducted in the presence of a metal catalyst. The type of the metal catalyst is not particularly limited, and conventional metal catalysts used for preparing polyester may be utilized. The metal catalyst may be used alone or used in combination with other types of metal catalysts. Examples of the metal catalyst include manganese-containing catalyst (such as manganese acetate), titanium-containing catalyst (such as titanium citrate), germanium-containing catalyst (such as germanium dioxide), antimony-containing catalyst (such as antimony trioxide), and zinc-containing catalyst (such as zinc acetate, etc.), but are not limited thereto. In certain embodiments, a metal element contained in the metal catalyst is present in amount of greater than 200 mg, based on a total amount of the furandicarboxylate polyester which is 1 kg. In certain embodiments, the metal element contained in the metal catalyst is present in an amount of greater than 200 mg and not greater than 600 mg, based on the total amount (1 kg) of the furandicarboxylate polyester.

The condensation and polymerization reaction includes a condensation reaction and a polymerization reaction. Examples of the condensation reaction include esterification reaction, transesterification reaction and polycondensation reaction. In certain embodiments, the condensation reaction is conducted at a temperature ranging from 200° C. to 250° C. for a time period ranging from 240 minutes to 360 minutes. In certain embodiments, the polymerization reaction is conducted at a temperature ranging from 250° C. to 300° C. for a time period ranging from 130 minutes to 450 minutes.

In certain embodiments, the solid-state polymerization reaction is conducted at a temperature ranging from 130° C. to 220° C. for a time period ranging from 48 hours to 120 hours. In certain embodiments, the solid-state polymerization reaction is conducted for a time period ranging from 48 hours to 100 hours. In certain embodiments, the solid-state polymerization reaction is conducted at a time period ranging from 60 hours to 100 hours.

According to the present disclosure, the furandicarboxylate polymer has a character index that ranges from 0.27 to 0.55 and that is calculated using the following Equation (I):

$$Character index = [ ( {AC}_{1} \times {Mn}_{1} \div ( 2 \times {10}^{6} ) ] , \qquad ( I )$$

where,
AC₁ represents an acid value of the furandicarboxylate polymer, and
Mn₁ represents a number average molecular weight of the furandicarboxylate polymer.
   To be specific, in determining the character index of the furandicarboxylate polymer of the present disclosure, the acid value and the number average molecular weight of the furandicarboxylate polymer are taken into consideration at the same time and the multiplication product of these two factors is being controlled to achieve a balance between the acid value and the number average molecular weight, so as to obtain the furandicarboxylate polymer having good thermal processing stability. The aforesaid consideration of the factors involved in determining the character index of the furandicarboxylate polymer has not been reported before.

In certain embodiments, the furandicarboxylate polymer has a variation of intrinsic viscosity that is less than 0.85 and that is calculated using the following Equation (II):

$$Variation of intrinsic viscosity = 0.245 \times [ {( {X}_{1} )}^{- 1.47} - {( {Y}_{1} )}^{- 1.47} ] , \qquad ( II )$$

where,
X₁ represents a first intrinsic viscosity of the furandicarboxylate polymer determined before a treatment, and
Y₁ represents a second intrinsic viscosity of the furandicarboxylate polymer determined after the treatment, in which the furandicarboxylate polymer is heated to a molten state and then kept in the molten state under constant temperature for 1 hour.
   To be specific, the molten state is achieved by treating the furandicarboxylate polymer at a heating temperature that ranges from a first temperature (i.e., the melting point (Tm) of the furandicarboxylate polymer plus 20° C.) to a second temperature (i.e., the melting point of the furandicarboxylate polymer plus 60° C.). In certain embodiments, the variation of intrinsic viscosity of the furandicarboxylate polymer is not smaller than 0.4 and less than 0.85.

In certain embodiments, the furandicarboxylate polymer has an intrinsic viscosity of greater than 0.55 dL/g. In certain embodiments, the intrinsic viscosity of the furandicarboxylate polymer is greater than 0.55 dL/g and not greater than 1.3 dL/g.

### <Furandicarboxylate Polymeric Pellets>

The furandicarboxylate polymer of the present disclosure may be in a form of furandicarboxylate polymeric pellets. Therefore, the present disclosure also provides furandicarboxylate polymeric pellets which has a character index that ranges from 0.27 to 0.55 and that is calculated using the following Equation (III):

$$Character index = [ ( {AC}_{2} \times {Mn}_{2} \div ( 2 \times {10}^{6} ) ] , \qquad ( III )$$

where,
AC₂ represents an acid value of the furandicarboxylate polymeric pellets, and
Mn₂ represents a number average molecular weight of the furandicarboxylate polymeric pellets.
   The furandicarboxylate polymeric pellets has an average particle size of greater than 1.5 mm. It is noted that AC₂ and Mn₂ in Equation (III) represent the properties of the furandicarboxylate polymeric pellets, while AC₁ and Mn₁ in Equation (I) represent the properties of the furandicarboxylate polymer. In the following description (see Examples section), the acid value of a material including the furandicarboxylate polymer or the furandicarboxylate polymeric pellets is represented by AC, and the number average molecular weight of the material including the furandicarboxylate polymer or the furandicarboxylate polymeric pellets is represented by Mn.

To be specific, in determining the character index of the furandicarboxylate polymeric pellets of the present disclosure, the acid value and the number average molecular weight of the furandicarboxylate polymeric pellets are taken into consideration at the same time and the multiplication product of these two factors is being controlled to achieve a balance between the acid value and the number average molecular weight, and in combination with the average particle size of the furandicarboxylate polymeric pellets, so as to obtain the furandicarboxylate polymeric pellets having good thermal processing stability. The aforesaid consideration of the factors involved in determining the character index of the furandicarboxylate polymeric pellets has not been reported before.

In certain embodiments, the average particle size of the furandicarboxylate polymeric pellets is greater than 1.5 mm and not greater than 6.0 mm. In certain embodiments, the average particle size of the furandicarboxylate polymeric pellets ranges from 1.8 mm to 6.0 mm. To be specific, with the average particle size of the furandicarboxylate polymeric pellets being greater than 1.5 mm, in comparison with other furandicarboxylate polymeric pellets having an average particle size of not greater than 1.5 mm, the furandicarboxylate polymeric pellets of the present disclosure has a relatively small specific surface area, which can prevent the ester group of the furandicarboxylate polymeric pellets from being exposed, thereby reducing the possibility of the ester group being directly heated, so as to avoid thermal degradation of the furandicarboxylate polymeric pellets. In addition, with the character index of the furandicarboxylate polymeric pellets being controlled to range from 0.27 to 0.55, the thermal processing stability of the furandicarboxylate polymeric pellets can be further improved.

In certain embodiments, the furandicarboxylate polymeric pellets have a variation of intrinsic viscosity that is less than 0.85 and that is calculated using the following Equation (IV):

$$Variation of intrinsic viscosity = 0.245 \times [ {( {X}_{2} )}^{- 1.47} - {( {Y}_{2} )}^{- 1.47} ] , \qquad ( IV )$$

X₂ represents a first intrinsic viscosity of the furandicarboxylate polymeric pellets determined before a treatment, and
Y₂ represents a second intrinsic viscosity of the furandicarboxylate polymeric pellets determined after the treatment, in which the furandicarboxylate polymeric pellets are heated to a molten state and then kept in the molten state under constant temperature for 1 hour. It is noted that X₂ and Y₂ in Equation (IV) represent the properties of the furandicarboxylate polymeric pellets, while X₁ and Y₁ in Equation (II) represent the properties of the furandicarboxylate polymer. In the following description (see Examples section), a first intrinsic viscosity of a material including the furandicarboxylate polymer or the furandicarboxylate polymeric pellets before the treatment is represented by X, and the second intrinsic viscosity of the material including the furandicarboxylate polymer or the furandicarboxylate polymeric pellets after the treatment is represented by Y. To be specific, the molten state is achieved by treating the furandicarboxylate polymeric pellets at a heating temperature that ranges from a first temperature (i.e., the melting point (Tm) of the furandicarboxylate polymeric pellets plus 20° C.) to a second temperature (i.e., the melting point of the furandicarboxylate polymeric pellets plus 60° C.). In certain embodiments, the variation of intrinsic viscosity of the furandicarboxylate polymeric pellets is not smaller than 0.4 and less than 0.85.

In certain embodiments, the furandicarboxylate polymeric pellets have an intrinsic viscosity of greater than 0.55 dL/g. In certain embodiments, the intrinsic viscosity of the furandicarboxylate polymeric pellets is greater than 0.55 dL/g and not greater than 1.3 dL/g.

According to the present disclosure, the furandicarboxylate polymeric pellets may be formed from and including the aforesaid components of the furandicarboxylate polymer. In certain embodiments, the furandicarboxylate polymeric pellets include at least one of ester particles formed from the aforesaid furandicarboxylate polymer and solid-state polymerized polyester particles formed by subjecting the ester particles to the solid-state polymerization reaction.

According to the present disclosure, the aforesaid components for forming the furandicarboxylate polymeric pellets may further include an additive. Examples of the additive include stabilizers, antioxidant agents and nucleating agents, but are not limited thereto. Examples of the stabilizers include phosphite ester compounds and phosphate ester compounds, but are not limited thereto. Examples of the antioxidant agents include, trialkyl phosphites, mixed alkyl/aryl phosphites, alkylated aryl phosphites, sterically hindered aryl phosphites, aliphatic spirocyclic phosphites, sterically hindered phenyl spirocylics, sterically hindered bisphosphonites, alkyl phosphates, aryl phosphates, mixed alkyl/aryl phosphates, alkylphosphonoacetates, hydroxyphenyl propionates, hydroxyl benzyls, alkyl phenols, aromatic amines, hindered amines, and hydroquinones, but are not limited thereto.

Examples of the nucleating agents include inorganic materials, organic salts, high melting waxes, or polymers. Examples of the inorganic materials include talc, titanium dioxide, fused silica, boron nitride, mica, and calcium carbonate, but are not limited thereto. Examples of the organic salts include fatty acid salts and aromatic acid salts, but are not limited thereto. An example of the fatty acid salts includes stearate salts. Examples of the stearate salts include sodium stearate and zinc stearate, but are not limited thereto. Examples of the aromatic acid salts include salts of benzoic acid, aromatic phosphonates, sulfonic acid ester salts of isophthalic acid, sodium salt of saccharine, furandicarboxylic disodium salt, and phosphate ester salts which are commercially available such as Millad®3988, Millad®NX88, NA-11 and NA-21, but are not limited thereto. Examples of the high melting waxes include stearamides, erucamides, or bis-amides. Examples of the polymers include ionomers, polyethylene glycol, polyethylene terephthalate, and polybutylene terephthalate, but are not limited thereto. Examples of the ionomers include Surlyn ionomers from Du Pont and Aculyn ionomers from Rohm and Haas, but are not limited thereto.

According to the present disclosure, the furandicarboxylate polymer and the furandicarboxylate polymeric pellets may be used to form a polymeric product such as packaging containers and packaging films.

### <Polymeric Product>

The polymeric product includes the furandicarboxylate polymer. Examples of the polymeric product include formed fibers, packaging containers, packaging films, and oriented tape for bundling, but are not limited thereto.

The present disclosure will be described by way of the following examples. However, it should be understood that the following examples are intended solely for the purpose of illustration and should not be construed as limiting the present disclosure in practice.

### Preparation of Furandicarboxylate Polyester

### Example 1 (EX1)

First, 465 g of dimethyl furan-2,5-dicarboxylate, 376 g of ethylene glycol, 0.023 g of phosphoric acid, 0.138 g of antimony trioxide, and 0.129 g of zinc acetate were mixed to form a mixture. Next, the mixture was heated to 235° C. to allow an esterification reaction to be conducted for 4 hours under a nitrogen atmosphere and to simultaneously distill off methanol. Then, a polymerization reaction was conducted at a temperature of 250° C. and a pressure of 0.8 torr for 227 minutes, so as to obtain a furandicarboxylate polyester. Thereafter, the furandicarboxylate polyester was subjected to a stretching treatment, followed by a cutting treatment, so as to obtain furandicarboxylate polyester pellets of Example 1 (EX1) which had an intrinsic viscosity of 0.566 dL/g and an average particle size of 3.7 mm. In the furandicarboxylate polyester pellets of EX 1, the amounts of phosphoric acid, antimony trioxide and zinc acetate were 50 mg, 300 mg and 280 mg, respectively, based on the total amount of the furandicarboxylate polyester of EX1 which was 1 kg.

### Examples 2 to 9 (EX2 to EX9) and Comparative Examples 1 to 6 (CE1 to CE6)

The procedures and conditions for preparing the furandicarboxylate polyester pellets of Examples 2 to 9 (EX2 to EX9) and Comparative Examples 1 to 6 (CE1 to CE6) were substantially similar to those of EX1, except for the following differences: (i) instead of using zinc acetate as the catalyst, the furandicarboxylate polyester pellets of EX5 and EX8 were prepared using 0.006912 g of titanium chelate (Manufacturer: Borica; Catalogue no.: AQ5000) serving as the catalyst, and based on the total amount of the furandicarboxylate polyester of each of EX8 and EX15 which was 1 kg, the titanium chelate serving as the catalyst was present in an amount of 15 mg; (ii) for preparing the furandicarboxylate polyester pellets of EX9 and CE6, 394 g of 2,5-furandicarboxylic acid was used to replace dimethyl furan-2,5-dicarboxylate, and an amount of ethylene glycol was changed from 376 g to 188 g, and zinc acetate was omitted; (iii) for preparing the furandicarboxylate polyester pellets of EX2 to EX9 and CE1 to CE6, the polymerization reaction was conducted at 250° C. for time periods of 193 minutes, 191 minutes, 173 minutes, 390 minutes, 356 minutes, 430 minutes, 203 minutes, 135 minutes, 230 minutes, 200 minutes, 415 minutes, 172 minutes, 233 minutes and 155 minutes, respectively, and at pressures of 0.78 torr, 0.75 torr, 0.8 torr, 0.81 torr, 0.72 torr, 0.85 torr, 0.81 torr, 0.78 torr, 0.82 torr, 0.85 torr, 0.73 torr, 0.72 torr, 0.85 torr and 0.82 torr, respectively.

### Preparation of Solid-State Polymerized Polyester

### Example 10 (EX10)

The furandicarboxylate polyester pellets of EX1 were subjected to a solid-state polymerization reaction at a temperature of 195° C. under a nitrogen atmosphere at normal pressure for 96 hours, so as to obtain a solid-state polymerized polyester having an intrinsic viscosity of 1.03 dL/g and an average particle size of 3.7 mm.

### Examples 11 to 18 (EX11 to EX18) and Comparative Examples 7 to 11 (CE7 to CE11)

The procedures and conditions for preparing the solid-state polymerized polyester of Examples 11 to 18 (EX11 to EX18) and Comparative Examples 7 to 11 (CE7 to CE11) were substantially similar to those of EX10, except for the differences in the type of the furandicarboxylate polyester pellets and the time period for conducting the solid-state polymerization reaction, as shown in Tables 3 and 4 below.

### Property Evaluation

Samples of EX1 to EX9 and CE1 to CE (furandicarboxylate polyester pellets) and samples of EX10 to EX18 to CE7 to CE11 (solid-state polymerized polyester pellets) were subjected to measurements described below. The results for the measurements are listed in Tables 1 to 4.

### 1. Intrinsic Viscosity Before Treatment

Each sample was subjected to measurement of intrinsic viscosity before treatment (unit: dL/g) using standard test method for determining inherent viscosity of poly(ethylene terephthalate) by glass capillary viscometer according to the procedures set forth in ASTM D4603 (published in 2018). First, each sample was added to a solvent containing phenol that was present in an amount of 60 wt % and 1,1,2,2-tetrachloroethane that was present in an amount of 40 wt % so as to form a solution mixture, in which the concentration of each sample was 3.25 g/L. Next, the solution mixture was heated at 110° C.±10° C. for 20 minutes, and then subjected to cooling, so as to form a test sample. Thereafter, the test sample was subjected to measurement at 30° C. using a viscometer (Manufacturer: CANNON; Model no.: MiniPV-HX), so as to obtain a relative viscosity. Afterwards, the instrinsic viscosity before treatment was determined from the relative viscosity using Billmeyer equation, which was represented by the following Equation (V):

$$IV = [ RV - 1 + 3 \times ln ( RV ) ] \div ( 4 \times SC ) \qquad ( V )$$

where,
IV represents an intrinsic viscosity,
RV represents relative viscosity, and
SC represent the concentration of each sample in the solution mixture.

### 2. Average Particle Size

First, 300 g of each sample was subjected to filtration using stainless steel standard analytical sieves (Kuang Yang) with different sizes of meshes, and then the weights of portions of each sample that are respectively filtered out by the stainless steel standard analytical sieves with different meshes were recorded, so as to determine the average particle size (unit: mm) of each sample. It is noted that the average particle size of each of the samples of EX10, EX11, EX 12, EX 13, EX 14, EX 15, EX 16, EX 17, EX18, CE7, CE8, CE9, CE10, and CE11 was substantially the same as a corresponding one of the samples of EX1, EX2, EX3, EX4, EX5, EX6, EX7, EX8, EX9, CE1, CE2, CE3, CE5, CE6, and thus, the average particle size for EX10 to EX18 and CE7 to CE11 are not listed in Tables 3 and 4.

### 3. Number Average Molecular Weight (Mn)

First, each sample in an amount ranging from 0.04 g to 0.08 g was dissolved in 0.5 mL of hexafluoroisopropanol at room temperature, so as to obtain a first mixture. At the same, chloroform and chlorophenol were mixed in a volume ratio of 1:1, so as to obtain a second mixture having a volume of 4.5 mL. Next, the first mixture and the second mixture were mixed to obtain a test sample. Thereafter, the test sample was subjected to determination of number average molecular weight using a gel permeation chromatography system (Manufacturer: Waters Corporation; Model no.: 2695) with Shodex K-803 or Shodex K-802 chromatography column at 40° C.

### 4. Acid Value (Carboxyl End Group Content)

Each sample was subjected to acid value measurement (unit: meq/kg) using standard test method for carboxyl end group content of polyethylene terephthalate yarns according to the procedures set forth in ASTM D7409 (published in 2020). First, 3 to 5 drops of bromophenol blue (serving as an indicator) was added to 25 mL of a solvent containing phenol and chloroform (a weight ratio of phenol to chloroform in the solvent was 3:2), followed by adding a titrant (i.e., a potassium hydroxide solution containing potassium hydroxide at a concentration of 0.1 N and benzyl alcohol) until the color turned completely blue color, i.e., the titration end point, and then determining the volume (V₀) of the potassium hydroxide solution added at the titration end point (i.e., the volume (V₀) was determined in the absence of the sample). Next, each sample in an amount ranging from 2 g to 4 g was dissolved in another solvent (25 mL) containing phenol and chloroform (a weight ratio of phenol to chloroform in the solvent was 3:2), so as to form a solution mixture. Thereafter, 3 to 5 drops of bromophenol blue (serving as an indicator) was added to the solution mixture, followed by adding another potassium hydroxide solution (serving as a titrant and containing potassium hydroxide at a concentration of 0.1 N and benzyl alcohol) until the color of the solution mixture turned completely blue color, i.e., the titration end point, and then determining the volume (V₁) of the potassium hydroxide solution added at the titration end point in the presence of the sample. Afterwards, the acid value of the test sample was calculated using the following Equation (VI):

$$AC = [ ( {V}_{1} - {V}_{0} ) \times N \times 1000 ] \div W \qquad ( VI )$$

where,
AC represents an acid value of the sample (i.e., carboxyl end group content of the sample),
V₀ represents the volume of the potassium hydroxide solution added at the titration end point in the absence of the sample,
V₁ represents the volume of the potassium hydroxide solution added at the titration end point in the presence of the sample,
N represents equivalent concentration of potassium hydroxide in the potassium hydroxide solution, and
W represents a weight of the sample (gram).

### 5. Character Index

The character index of each sample was calculated using the following Equation (VII):

$$( AC \times Mn ) \div ( 2 \times {10}^{6} ) \qquad ( VII )$$

where,
AC represents an acid value of each sample (furandicarboxylate polyester pellets or solid-state polymerized polyester pellets), and
Mn represents a number average molecular weight of each sample (furandicarboxylate polyester pellets or solid-state polymerized polyester pellets).

### 6. Variation of Intrinsic Viscosity

First, each sample in an amount of 1.0 g was subjected to a drying treatment at 100° C. for 10 minutes, followed by increasing the temperature in airy environment until the sample was in a molten state, and then the temperature was kept constant for 1 hour such that the sample were kept in the molten state. Next, an instant cooling treatment was performed using liquid nitrogen, followed by placement in an oven at a temperature set at 50° C. for a drying treatment, thereby obtaining a dried sample. Thereafter, the dried sample was subjected to measurement of intrinsic viscosity as described in Item 1 above, so as to obtain intrinsic viscosity of the dried sample (Y, unit: dL/g). The variation of intrinsic viscosity was calculated by substituting the intrinsic viscosity of the sample before treatment as determined in Item 1 (X, unit: dL/g) and the intrinsic viscosity of the dried sample (Y, unit: dL/g) into the following Equation (VIII):

$$Variation of intrinsic viscosity = 0.245 \times [ {( X )}^{- 1.47} - {( Y )}^{- 1.47} ] \qquad ( VIII )$$

It should be noted that the melting points for the samples EX1 to EX9 and CE1 to CE6 (i.e., the furandicarboxylate polyester pellets) were 204° C., 198° C., 197° C., 195° C., 197° C., 201.5° C., 197° C., 199° C., 200° C., 205° C., 196° C., 197° C., 196° C., 196° C. and 203° C., respectively, while the melting points of the samples of EX10 to EX18 to CE7 to CE11 (i.e., the solid-state polymerized polyesters pellets) were 215° C., 212° C., 210° C., 206° C., 205° C., 215° C., 210° C., 216° C., 215° C., 211° C., 208° C., 206° C., 208° C. and 212° C., respectively. The molten state for each sample was achieved at a temperature of 250° C.

### 7. Rate of Increase in Intrinsic Viscosity

The rates of increase in intrinsic viscosity [unit: (ΔdL/g)/hour] for the samples of EX10, EX11, EX 12, EX 13, EX 14, EX 15, EX 16, EX 17, EX18, CE7, CE8, CE9, CE10, and CE11 (i.e., the solid-state polymerized polyesters pellets) were calculated respectively based on a corresponding one of the samples of EX1, EX2, EX3, EX4, EX5, EX6, EX7, EX8, EX9, CE1, CE2, CE3, CE5, CE6 (i.e., furandicarboxylate polyester pellets) (see also Tables 3 and 4). The rate of increase in intrinsic viscosity was calculated using the following Equation (IX):

$$RA = ( IVS - IVF ) \div T \qquad ( IX )$$

where,
RA represents a rate of increase in intrinsic viscosity,
IVS represents an intrinsic viscosity of solid-state polymerized polyester pellets in a corresponding one of the samples of EX10, EX11, EX 12, EX 13, EX 14, EX 15, EX 16, EX 17, EX18, CE7, CE8, CE9, CE10, and CE11, and
IVF represents an intrinsic viscosity of furandicarboxylate polyester pellets in a corresponding one of the samples of EX1, EX2, EX3, EX4, EX5, EX6, EX7, EX8, EX9, CE1, CE2, CE3, CE5, and CE6, and
T represents a time period for conducting solid-state polymerization reaction in the corresponding one of the samples of EX10, EX11, EX12, EX13, EX14, EX15, EX16, EX17, EX18, CE7, CE8, CE9, CE10, and CE11.

TABLE 1

| Furandicarboxylate | | | | | | | | | |
|---|---|---|---|---|---|---|---|---|---|
| polyester pellets | EX1 | EX2 | EX3 | EX4 | EX5 | EX6 | EX7 | EX8 | EX9 |
| Intrinsic viscosity | 0.566 | 0.552 | 0.569 | 0.574 | 0.811 | 0.808 | 0.829 | 0.558 | 0.565 |
| (dL/g) | | | | | | | | | |
| Average particle | 3.7 | 5.3 | 5.8 | 4.8 | 2.5 | 4.3 | 1.8 | 2.8 | 3.0 |
| size (mm) | | | | | | | | | |
| Number average | 20946 | 20316 | 21081 | 21308 | 32478 | 32332 | 33359 | 20585 | 20901 |
| molecular weight | | | | | | | | | |
| Acid value (meq/kg) | 28.4 | 37.7 | 42 | 51.4 | 21.8 | 17.2 | 32.2 | 46 | 44 |
| Character index | 0.297 | 0.383 | 0.443 | 0.548 | 0.354 | 0.278 | 0.537 | 0.473 | 0.46 |
| Variation of intrinsic | 0.789 | 0.817 | 0.771 | 0.846 | 0.758 | 0.734 | 0.814 | 0.807 | 0.445 |
| viscosity | | | | | | | | | |

TABLE 2

| Furandicarboxylate | | | | | | |
|---|---|---|---|---|---|---|
| polyester pellets | CE1 | CE2 | CE3 | CE4 | CE5 | CE6 |
| Intrinsic viscosity | 0.564 | 0.542 | 0.803 | 0.574 | 0.585 | 0.557 |
| (dL/g) | | | | | | |
| Average particle | 2.3 | 4.2 | 3.4 | 1.3 | 3.1 | 2.8 |
| size (mm) | | | | | | |
| Number average | 20856 | 19868 | 32088 | 21308 | 21807 | 20540 |
| molecular weight | | | | | | |
| Acid value (meq/kg) | 20.8 | 63.5 | 37.2 | 51.4 | 13.4 | 16.3 |
| Character index | 0.217 | 0.631 | 0.597 | 0.548 | 0.146 | 0.167 |
| Variation of intrinsic | 1.195 | 1.076 | 0.988 | 0.905 | 1.231 | 1.156 |
| viscosity | | | | | | |

As shown in Tables 1 and 2, the character index of the furandicarboxylate polyester pellets of EX1 to EX9 ranges from 0.27 to 0.55, while the character index of the furandicarboxylate polyester pellets of EX1 to EX3 and CE5 and CE5 is less than 0.27 or greater than 0.55, such that the variation of intrinsic viscosity of the furandicarboxylate polyester pellets of EX1 to EX9 ranges from 0.445 to 0.846, and the variation of intrinsic viscosity of the furandicarboxylate polyester pellets of CE1 to CE3 and CE5 and CE6 ranges from 0.988 to 1.231, indicating that the furandicarboxylate polymer of the present disclosure would not easily undergo molecular breakage due to thermal degradation during thermal processing. In addition, the furandicarboxylate polyester pellets of CE4 had an average particle size of not greater than 1.5 mm, such that the variation of intrinsic viscosity of the furandicarboxylate polyester pellets of CE4 was greater than the variation of intrinsic viscosity of each of the furandicarboxylate polyester pellets of EX1 to EX9, indicating that in comparison with the furandicarboxylate polyester pellets of CE4, the furandicarboxylate polyester pellets of the present disclosure, which have an average particle size of greater than 1.5 mm and a character index ranging from 0.27 to 0.55, indeed have a good thermal processing stability.

TABLE 3

| | Solid-state polymerized polyester pellets | | | | | | | | |
|---|---|---|---|---|---|---|---|---|---|
| | EX10 | EX11 | EX12 | EX13 | EX14 | EX15 | EX16 | EX17 | EX18 |
| | Prepared from furandicarboxylate polyester pellets | | | | | | | | |
| | EX1 | EX2 | EX3 | EX4 | EX5 | EX6 | EX7 | EX8 | EX9 |
| Time period for | 96 | 72 | 72 | 72 | 60 | 72 | 68 | 72 | 72 |
| solid-state | | | | | | | | | |
| polymerization | | | | | | | | | |
| reaction (hours) | | | | | | | | | |
| Intrinsic viscosity | 1.03 | 1.052 | 1.04 | 1.025 | 1.161 | 1.088 | 0.973 | 1.015 | 1.02 |
| (dL/g) | | | | | | | | | |
| Number average | 43471 | 44606 | 43986 | 43214 | 50304 | 46474 | 40555 | 42700 | 42957 |
| molecular weight | | | | | | | | | |
| Acid value (meq/kg) | 12.5 | 21.8 | 18.4 | 25.0 | 19.2 | 16.7 | 25.8 | 23.5 | 22.2 |
| Character index | 0.272 | 0.486 | 0.405 | 0.540 | 0.483 | 0.388 | 0.523 | 0.502 | 0.477 |
| Variation of intrinsic | 0.586 | 0.454 | 0.507 | 0.579 | 0.646 | 0.589 | 0.688 | 0.547 | 0.542 |
| viscosity | | | | | | | | | |
| Rate of increase in | 5.26 | 7.03 | 6.90 | 6.44 | 5.93 | 4.00 | 2.28 | 6.83 | 6.63 |
| intrinsic viscosity | | | | | | | | | |
| [×10⁻³, | | | | | | | | | |
| (ΔdL/g)/hour] | | | | | | | | | |

TABLE 4

| Solid-state | | | | | |
|---|---|---|---|---|---|
| polymerized | | | | | |
| polyester pellets | CE7 | CE8 | CE9 | CE10 | CE11 |
| Prepared from | CE1 | CE2 | CE3 | CE5 | CE6 |
| furandicarboxylate | | | | | |
| polyester pellets | | | | | |
| Time period for | 192 | 252 | 144 | 228 | 240 |
| solid-state | | | | | |
| polymerization | | | | | |
| reaction (hours) | | | | | |
| Intrinsic viscosity | 0.882 | 0.853 | 1.01 | 1.002 | 1.003 |
| (dL/g) | | | | | |
| Number average | 35978 | 34541 | 42444 | 42034 | 42085 |
| molecular weight | | | | | |
| Acid value (meq/kg) | 6.2 | 40.2 | 36.9 | 10.5 | 11.3 |
| Character index | 0.112 | 0.694 | 0.783 | 0.221 | 0.238 |
| Variation of intrinsic | 0.945 | 0.932 | 0.892 | 1.015 | 1.058 |
| viscosity | | | | | |
| Rate of increase in | 1.72 | 1.27 | 1.49 | 1.88 | 1.91 |
| intrinsic viscosity | | | | | |
| [×10⁻³, | | | | | |
| (ΔdL/g)/hour] | | | | | |

As shown in Tables 3 and 4, the character index of the solid-state polymerized polyesters pellets of EX10 to EX18 ranges from 0.27 to 0.55, while the character index of the solid-state polymerized polyesters pellets of CE7 to CE11 is less than 0.27 or greater than 0.55, such that the variation of intrinsic viscosity of the solid-state polymerized polyester pellets of EX10 to EX18 ranges from 0.454 to 0.688, and the variation of intrinsic viscosity of the solid-state polymerized polyester pellets of CE7 to CE11 ranges from 0.892 to 1.058, indicating that the solid-state polymerized polyester pellets of the present disclosure would not easily undergo molecular breakage due to thermal degradation during thermal processing.

In summary, by having a character index ranging from 0.27 to 0.55, the furandicarboxylate polymeric pellets and the furandicarboxylate polymer of the present disclosure, when subjected to thermal processing, the problem of ester bond breakage due to thermal degradation would not occur easily, so the desired properties of the furandicarboxylate polymeric pellets and the furandicarboxylate polymer can be maintained, and thus the furandicarboxylate polymeric pellets and the furandicarboxylate polymer have an advantage of good thermal processing stability, thereby meeting the requirements of economic benefits of commercial mass production.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A furandicarboxylate polymer, having:
a character index that ranges from 0.27 to 0.55 and that is calculated using the following Equation (A):
$$Character index = [ ( {AC}_{1} \times {Mn}_{1} \div ( 2 \times {10}^{6} ) ] , \qquad ( A )$$
where,
AC₁ represents an acid value of the furandicarboxylate polymer, and
Mn₁ represents a number average molecular weight of the furandicarboxylate polymer.

2. The furandicarboxylate polymer as claimed in claim 1, wherein the furandicarboxykate polymer has a variation of intrinsic viscosity that is less than 0.85 and that is calculated using the following Equation (B):
$$Variation of intrinsic viscosity = 0.245 \times [ {( {X}_{1} )}^{- 1.47} - {( {Y}_{1} )}^{- 1.47} ] , \qquad ( B )$$
where,
X₁ represents a first intrinsic viscosity of the furandicarboxylate polymer determined before a treatment, and
Y₁ represents a second intrinsic viscosity of the furandicarboxylate polymer determined after the treatment, the furandicarboxylate polymer in the treatment being heated to a molten state and then kept in the molten state under constant temperature for 1 hour.

3. The furandicarboxylate polymer as claimed in claim 2, wherein the variation of intrinsic viscosity of the furandicarboxylate polymer is not smaller than 0.4 and less than 0.85.

4. The furandicarboxylate polymer as claimed in claim 1, wherein an intrinsic viscosity of the furandicarboxylate polymer is greater than 0.55 dL/g.

5. The furandicarboxylate polymer as claimed in claim 1, wherein
the furandicarboxylate polymer is formed by subjecting a reactant composition including a polycarboxylic component and a polyol component to a reaction, the polycarboxylic component including at least one polycarboxylic compound selected from furandicarboxylic acid or furandicarboxylic acid diester, the polyol component including at least one C₂-C₄ polyol compound,
the C₂-C₄ polyol compound is present in an amount that is not smaller than 85 mol % and less than 100 mol % based on 100 mol % of the polyol component, and
the polycarboxylic compound is present in an amount that is not smaller than 80 mol % and less than 100 mol % based on 100 mol % of the polycarboxylic component.

6. The furandicarboxylate polymer as claimed in claim 1, wherein the furandicarboxylate polymer is in a form of furandicarboxylate polymeric pellets having an average particle size of greater than 1.5 mm.

7. The furandicarboxylate polymer as claimed in claim 6, wherein the average particle size of the furandicarboxylate polymeric pellets is greater than 1.5 mm and not greater than 6.0 mm.

8. The furandicarboxylate polymer as claimed in claim 7, wherein the average particle size of the furandicarboxylate polymeric pellets ranges from 1.8 mm to 6.0 mm.

9. The furandicarboxylate polymer as claimed in claim 6, wherein the furandicarboxykate polymeric pellets have a variation of intrinsic viscosity that is less than 0.85 and that is calculated using the following Equation (C):
$$Variation of intrinsic viscosity = 0.245 \times [ {( {X}_{2} )}^{- 1.47} - {( {Y}_{2} )}^{- 1.47} ] , \qquad ( C )$$
where,
X₂ represents a first intrinsic viscosity of the furandicarboxylate polymeric pellets determined before a treatment, and
Y₂ represents a second intrinsic viscosity of the furandicarboxylate polymeric pellets determined after the treatment, the furandicarboxylate polymeric pellets in the treatment being heated to a molten state and then kept in the molten state under constant temperature for 1 hour.

10. The furandicarboxylate polymer as claimed in claim 9, wherein the variation of intrinsic viscosity of the furandicarboxylate polymeric pellets is not smaller than 0.4 and less than 0.85.

11. The furandicarboxylate polymer as claimed in claim 6, wherein an intrinsic viscosity of the furandicarboxylate polymeric pellets is greater than 0.55 dL/g.

12. The furandicarboxylate polymer as claimed in claim 6, wherein
the furandicarboxylate polymeric pellets are formed by subjecting a reactant composition including a polycarboxylic component and a polyol component to a reaction, the polycarboxylic component including at least one polycarboxylic compound selected from furandicarboxylic acid or furandicarboxylic acid diester, the polyol component including at least one C₂-C₄ polyol compound,
the C₂-C₄ polyol compound is present in an amount that is not smaller than 85 mol % and less than 100 mol % based on 100 mol % of the polyol component, and
the polycarboxylic compound is present in an amount that is not smaller than 80 mol % and less than 100 mol % based on 100 mol % of the polycarboxylic component.
